(19) United States
(12) Patent Application Publication
(10) Pub. No.: US 2004/0263491 A1
(43) Pub. Date: Dec. 30, 2004

(54) Data processing apparatus and function selection method

(76) Inventor: Satoru Ishigaki, Ome-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/834,265

(22) Filed: Apr. 29, 2004

(30) Foreign Application Priority Data
Apr. 30, 2003 (JP) 2003-125638

(51) Int. Cl. G09G 5/00

(52) U.S. Cl. 345/177

(57) ABSTRACT

A data processing apparatus comprises a display device, a touch input device, a detector which detects a touch operation of the touch input device, a display controller which displays an operation window listing executable functions on the display device, when the touch operation is detected by the detector, and a start-up unit which starts up a function selected from the operation window displayed on the display means.

### CROSS-REFERENCE TO RELATED APPLICATIONS

This application is based upon and claims the benefit of priority from prior Japanese Patent Application No. 2003-125638, filed Apr. 30, 2003, the entire contents of which are incorporated herein by reference.

### BACKGROUND OF THE INVENTION

1. Field of the Invention

The present invention relates to a data processing apparatus and a function selection method for use in an apparatus capable of selectively executing plural functions.

2. Description of the Related Art

Portable personal computers of a notebook type or laptop type have recently been provided with a pointing device which enables, for example, a mouse pointing operation and a numeric key input operation (e.g., refer to Japanese Patent KOKAI Publication No. 2000-339097).

In this kind of conventional personal computer, the functions of the pointing device are limited to a narrow specific range, and the operationality involves several problems.

### BRIEF SUMMARY OF THE INVENTION

The present invention is directed to method and apparatus that substantially obviates one or more of the problems due to limitations and disadvantages of the related art.

According to an embodiment of the present invention, a data processing apparatus comprises a display device, a touch input device, a detector which detects a touch operation of the touch input device, a display controller which displays an operation window listing executable functions on the display device, when the touch operation is detected by the detector, and a start-up unit which starts up a function selected from the operation window displayed on the display means.

According to an embodiment of the present invention, a function selection method for use in an apparatus comprising an operation device which inputs coordinates of an operating position on an operation surface of the operation device and a display device which displays a display screen where an operation on the operation device is reflected, the method comprises displaying an operation window for selecting executable functions of the apparatus on the display device when an operation surface of the operation device is touched, and executing a function selected from the operation window when a state in which the operation surface of the operation device is touched is stopped.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a perspective view showing an external structure of a data processing apparatus according to a first embodiment of the present invention;

FIG. 2 is a block diagram showing the system configuration of the computer shown in FIG. 1;

FIGS. 3A and 3B are views showing an operation procedure and a state transition in the first embodiment of the present invention;

FIG. 4 is a flowchart showing a processing procedure in the first embodiment;

FIG. 5 is shows an example of the configuration of a setting screen in a second embodiment of the present invention;

FIG. 6 is a view showing an example of the configuration of a desktop table in the second embodiment;

FIG. 7 is a view showing an example of the configuration of a switch window table (window list table) in the second embodiment;

FIG. 8 is a view showing an example of the configuration of a custom table in the second embodiment;

FIG. 9 a view showing an example of the configuration of a custom table setting window in the second embodiment;

FIG. 10 is a view showing an example of the configuration of a detail setting window for switch window table in the second embodiment;

FIG. 11 is a flowchart showing a setting processing procedure with use of a main setting window in the second embodiment;

FIG. 12 is a flowchart showing an item setting processing procedure for the custom table in the second embodiment;

FIG. 13 is a flowchart showing a processing procedure based on the example of setting shown in FIG. 5 in the second embodiment; and

FIG. 14 is a flowchart showing a processing procedure for displaying the switch window in the second embodiment.

### DETAILED DESCRIPTION OF THE INVENTION

An embodiment of a data processing apparatus according to the present invention will now be described with reference to the accompanying drawings.

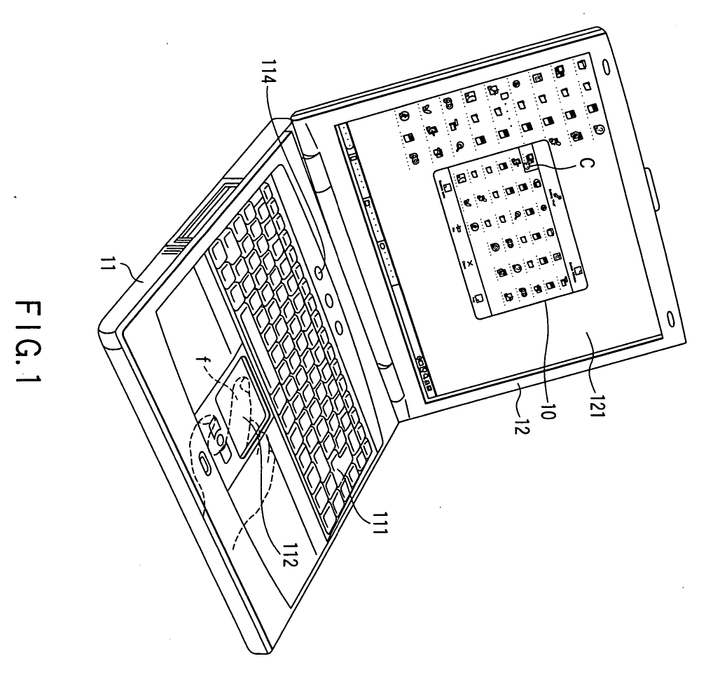

FIG. 1 shows the exterior structure of a data processing apparatus according to the embodiment of the present invention. A notebook type personal computer is exemplified in this embodiment.

The computer according to the embodiment comprises a main body 11 and a display unit 12. The display unit 12 incorporates a display device 121 comprising an LCD. The display unit 12 is attached to the main body 11 to be freely rotatable between opened and closed positions. The main body 11 has a thin box-like housing. A power button 114 to turn on/off the power of the computer, a keyboard 111, and the like are arranged on the upper surface of the housing. An armrest is formed on the upper surface of the part before the keyboard 111. A touch pad 112 is provided in the substantial center of the armrest. The touch pad 112 is provided with a function to detect a touched position and a touch/move/release of a finger.

An operation window 10 for selecting functions as shown in FIG. 1 is displayed on the display screen of the display device 121, upon an operation of touching a predetermined region on the operation surface of the touch pad 112. The entire operation window 10 corresponds to the entire operation surface of the touch pad 112. A cursor C indicating the operating position on the operation surface of the touch pad 112 is displayed on the operation window 10. The coordinate system for the operation surface of the touch pad 112 and that for the operation window 10 on the display screen of the display device 121 have a predetermined relation.

Suppose for example that a predetermined region on the operation surface of the touch pad 112 is touched by a finger f to display the operation window 10 on the display device 121. If the finger f is then moved on the operation surface of the touch pad 112 with the finger f kept in contact with the operation surface of the touch pad 112, the cursor C moves on the operation window 10 in accordance with the motion of the finger f. If the finger f is released from the operation surface of the touch pad 112 if the cursor C is pointed at a function (item icon) on the operation window 10, the function pointed by the cursor C starts up.

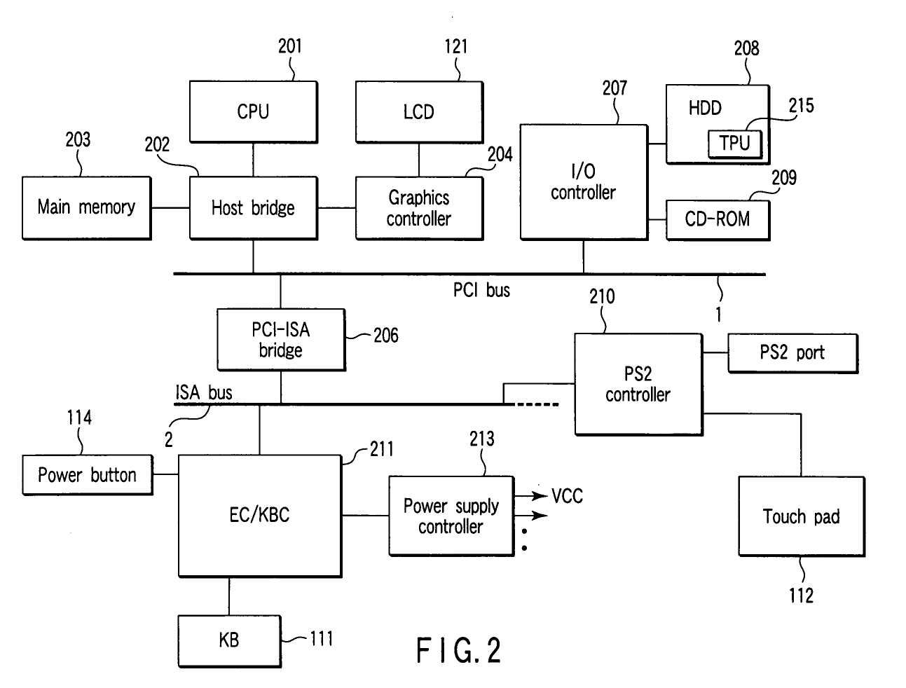

FIG. 2 shows the system configuration of the computer shown in FIG. 1.

The computer comprises a CPU 201, a host bridge 202, a main memory 203, a graphics controller 204, a PCI-ISA bridge 206, an I/O controller 207, a hard disk drive (HDD) 208, a CD-ROM drive 209, a PS2 controller 210, an embedded-controller/keyboard-controller IC (EC/KBC) 211, a power supply controller 213, etc.

The PS2 controller 210 is connected to the touch pad 112, and the graphics controller 204 is connected to the display device 121. The hard disk drive 208 stores a touch-pad utility program (TPU) 215 which realizes selection and execution of functions via the operation window 10.

The CPU 201 controls the computer to operate, and executes the operating system (OS) loaded from the hard disk drive (HDD) 208 onto the main memory 203, application programs, utility programs, etc. In this embodiment, a touch pad utility program (TPU) 215 loaded from the hard disk drive 208 onto the main memory 203 is executed to realize selection and execution of functions by operating the touch pad 112 as described above via the operation window 10. Processings to be performed at this time for the selection and execution of functions via the operation window 10 will be described later.

The host bridge 202 is a bridge device which connects bidirectionally a local bus of the CPU 201 and a PCI bus 1 to each other. The graphics controller 204 has a video RAM (VRAM), and controls the display device 121 used as a display monitor of the computer under control by a dedicated display driver. The I/O controller 207 controls the hard disk drive 208, the CD-ROM drive 209, and the like. The PCI-ISA bridge 206 is a bridge device which connects bidirectionally the PCI (Peripheral Component Interconnect) bus 1 and an ISA (Industry Standard Architecture) bus 2 to each other. The bridge 206 includes various system devices such as a system timer, DMA controller, interruption controller, and the like.

The embedded-controller/keyboard-controller IC (EC/KBD) 211 is a microcomputer made of one chip on which an embedded controller (EC) for managing the electric power and a keyboard controller (KBC) for controlling the keyboard 111. The embedded-controller/keyboard-controller IC (EC/KBC) 211 has a function to turn on/off the power of the computer in accordance with a user's operation on the power button 114, working in corporation with the power supply controller 213.

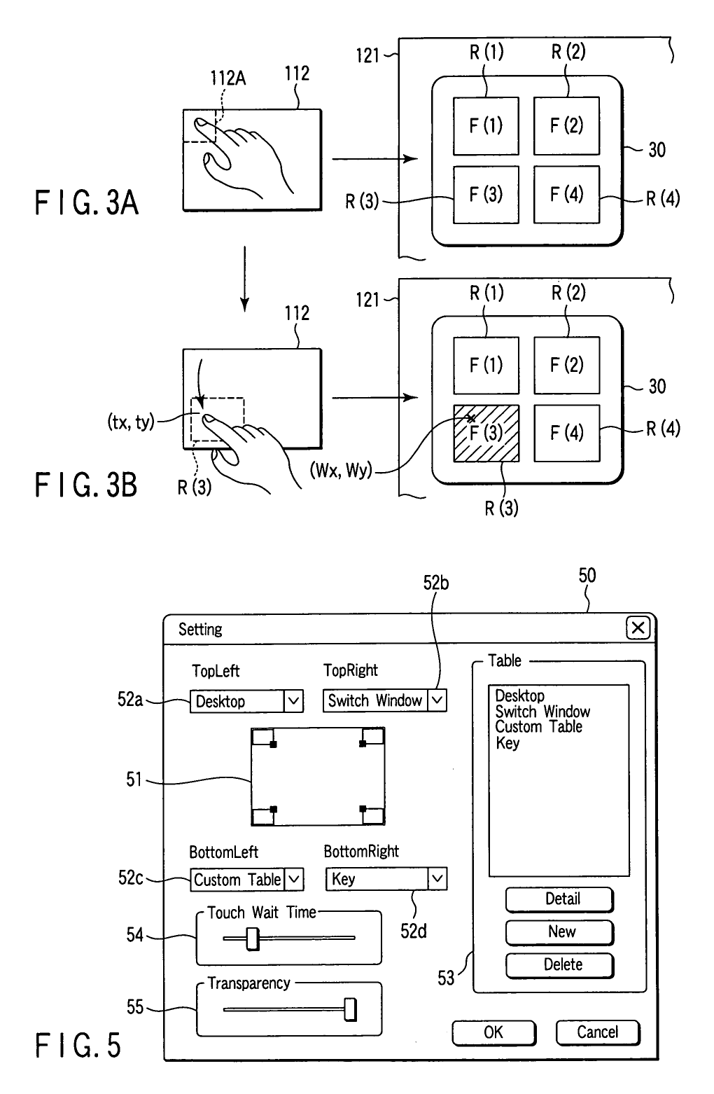

FIGS. 3A and 3B show an operation procedure and a state transition in the first embodiment of the present invention. To simplify the description below, the figures show an example of a window in which only four kinds of functions are selectable. An operation window (function-selection window) for selecting functions is displayed on the display device 121 upon the touch operation shown in FIG. 3A. A function is selected and executed upon the move operation shown in FIG. 3B.

In FIG. 3A, when a specific region 112A on the operation surface of the touch pad 112 is touched by a finger, an operation window 30 for selecting functions (the function selection window showing a list of selectable functions) is displayed on the display device 121. The operation window 30 respectively shows selectable functions F(1), F(2), F(3), and F(4) on regions R(1), R(2), R(3), and R(4). The entire operation window 30 corresponds to the entire operation surface of the touch pad 112. In this state, as the finger moves to the coordinates (tx, ty) on the operation surface of the touch pad 112, as shown in FIG. 3B, the function F(3) corresponding to the coordinates (wx, wy) on the operation window 30 which correspond to the operating position (coordinates (tx, ty)) on the operation surface of the touch pad 112 is selected. In this state, if the finger is released from the operation surface of the touch pad 112, the selected function F(3) is executed.

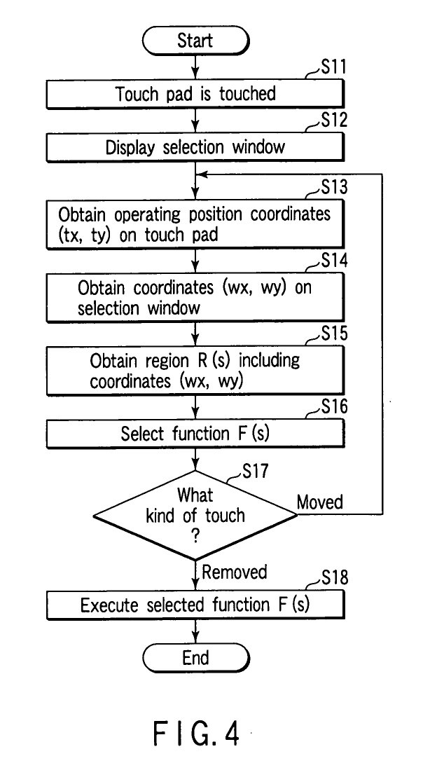

FIG. 4 shows a procedure of the processing in the first embodiment described above. When a specific region 112A on the operation surface of the touch pad 112 is touched by a finger, as shown in FIG. 3A, this touch is determined as an instruction input of a function selection operation, from the coordinates of the operating position. The operation window 30 is then displayed on the display device 121 (steps S11 and S12). If the finger contacting the operation surface of the touch pad 112 moves while the operation window 30 is displayed, as shown in FIG. 3B, the finger contacting position coordinates (tx, ty) are obtained (step S13), and the coordinates (wx, wy) on the operation window 30 are further obtained from the coordinates (tx, ty) (step S14). A region on the operation window 30 including the coordinates (wx, wy) is obtained, in this case, the region R3 is obtained (step S15). It is determined that a function corresponding to the region, in this case, the function F(3) is selected (step S16). It is determined whether the finger is released or moved in step S17. If the finger is released from the operation surface of the touch pad 112, the function F(3) which has been selected on the operation window 30 up to this time is executed. If the finger is moved with the finger kept in contact with the operation surface of the touch pad 112, a procedure is repeated from step S13.

As described above, when a finger touches the operation surface of the touch pad 112, the operation window 30 is displayed on the display device 121 to select a function. When this state transits to a state in which the finger is off of the operation surface, the function selected on the operation window 30 is executed. In this manner, each function can be selected and executed through minimum operations.

Other embodiments of the data processing apparatus according to the present invention will be described. The same portions as those of the first embodiment will be indicated in the same reference numerals and their detailed description will be omitted.

A second embodiment of the present invention will be described with reference to FIGS. 5 to 14.

FIG. 5 shows an example of the configuration of a setting window 50 displayed on the display device 121 for setting (assigning) functions on the operation surface of the touch pad 112, according to the second embodiment of the present invention. Exemplified in this embodiment will be the setting window 50 in which operation windows for selecting functions are assigned to corner regions of the operation surface of the touch pad 112. In this embodiment, each function is called an “item,” and each list of items is called a “table.” Provided in the setting window 50 shown in FIG. 5 are: a range setting section 51 for setting the range of each corner region (touch-sensible region); operation window setting sections 52a to 52d in form of list boxes for setting tables which form the operation windows for the respective corner regions; a table setting section 53 including buttons and a table list for instructing creation of a new table, deletion of a table, detailed setting, and the like; a window open time setting section 54 using a track bar for setting a touch wait time to confirm an operation of selecting any of corner regions set by the range setting section 51; a transparency setting section 55 using a track bar for setting the transparency of the operation window; etc. By using these setting sections, operation windows (function selection windows) can be set on (assigned to) arbitrary regions at the corners of the operation surface of the touch pad, considering the operationality. Processings for the setting using the setting window 50 will be described later with reference to FIG. 11.

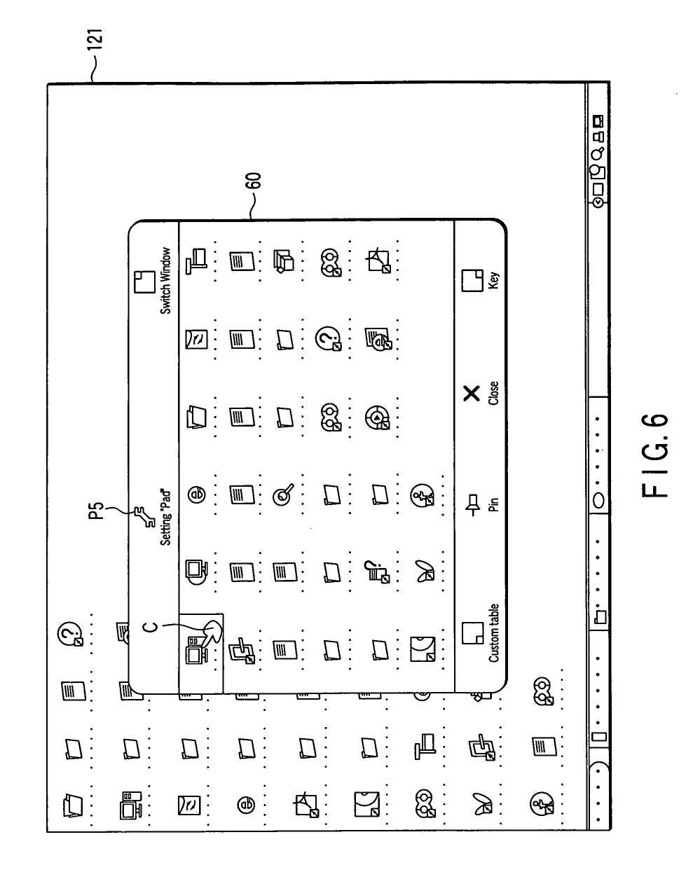

FIGS. 6, 7, and 8 show examples of the configurations of various tables which are set (defined) by the setting window 50. The configurations of these tables will be described later.

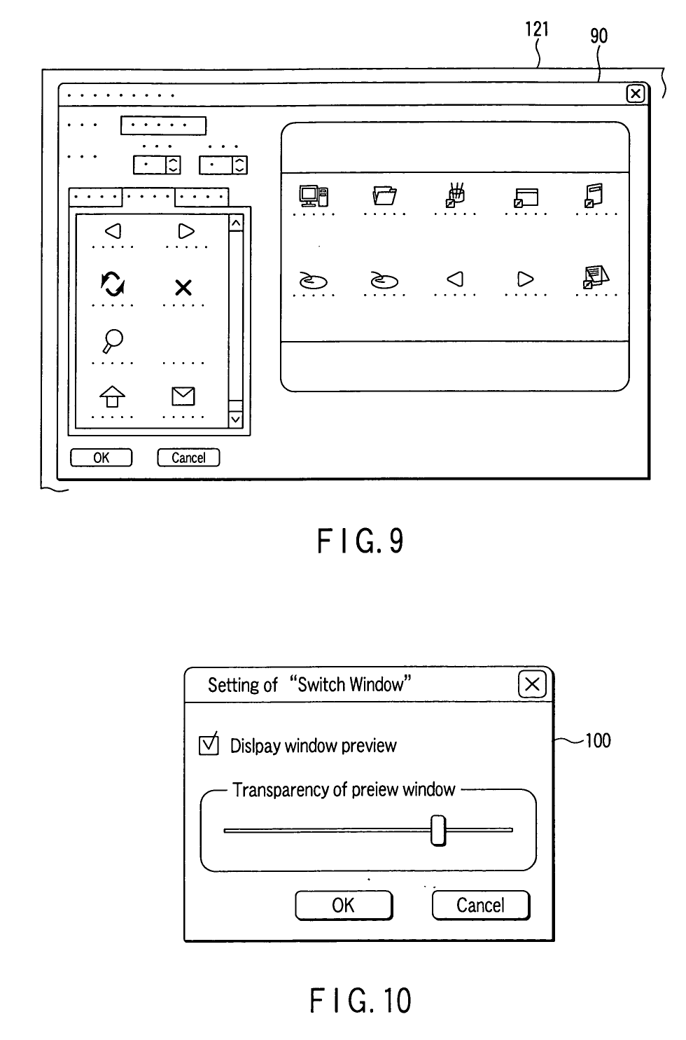

FIG. 9 shows an example of the configuration of a setting window for a custom table. The setting window is displayed when a setting item (Setting of Custom Table) is operated among the system items provided on each of the tables 60, 70, and 80. A further description will be made later with respect to setting by the setting window and functions according to contents of the setting.

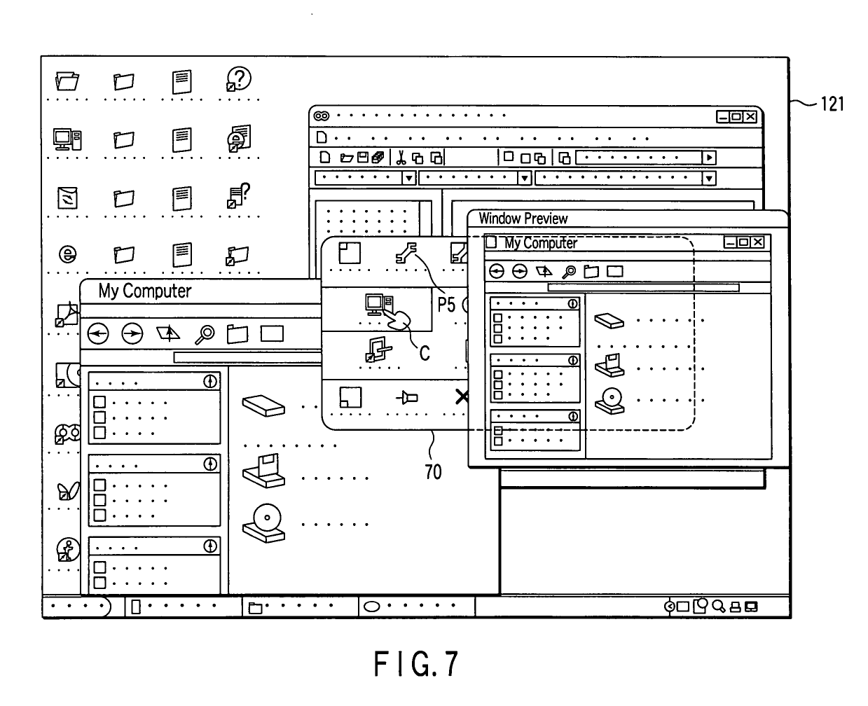

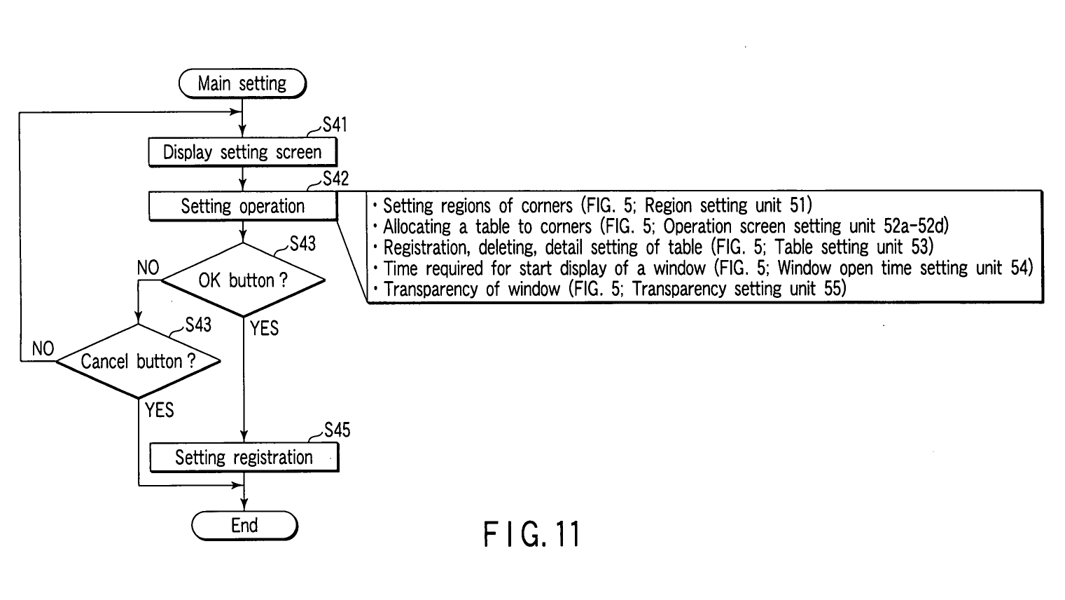

FIG. 10 shows an example of the configuration of a detail setting window 100 for setting details of the switch window table 70 shown in FIG. 7. A further description will be made later with respect to setting by the setting window and functions according to contents of the setting.

FIGS. 11 to 14 are flowcharts each showing a procedure of the processings according to the second embodiment of the present invention. The processings shown in the flowcharts are realized by the touch pad utility program (TPU) 215 which is executed by the CPU 201.

Operations according to the second embodiment of the present invention will now be described with reference to FIGS. 11 to 14.

Described at first will be anp outline of the second embodiment. In the second embodiment, the user can select an arbitrary table among the tables set by the user via the setting window 50, upon one touch on the touch pad 112. An arbitrary function can be selected and executed from the table. In the second embodiment, operation windows (tables) for selecting functions can be assigned to corner regions (at four corners) on the operation surface of the touch pad 112. That is, arbitrary tables can be respectively assigned to the four corners on the operation surface of the touch pad 112. In an example of FIG. 5, desktop, switch window, custom table, and key window are respectively assigned to top-left, top-right, bottom-left, and bottom-right corners on the operation surface of the touch pad 112.

Next, an outline of the procedure will be described. The user touches a certain region on the four corners of the operation surface of the touch pad 112, and keeps the touch within the certain region for a constant time period. Then, an operation window listing up executable functions shows up. At this time on the operation window, another cursor C indicative of the operating position on the operation surface of the touch pad 112 is displayed in addition to a normal cursor. By moving the finger on the operation surface of the touch pad 112 with the finger kept in contact with the operation surface of the touch pad 112, the cursor C on the operation window moves. In this case, the operating position on the operation surface of the touch pad 112 and the cursor position on the operation window correspond to each other. By moving the finger kept in touch with the operation surface of the touch pad 112, a function which the user desires to execute can be selected from the items on the operation window. When the finger is released, the selected item is executed.

In the second embodiment, any desired operation window (table) can be defined for use from the setting window 50 shown in FIG. 5. The setting window 50 is opened by operating a specific system item (Setting “Pad”) on the tables shown in FIGS. 6 to 8.

As has been described previously, the setting window 50 provided with the range setting section 51, operation window setting sections 52a to 52d, table setting section 53, window open time setting section 54, transparency setting section 55, and the like. With use of these setting sections, operation windows (tables) can be set on arbitrary regions at the corners of the operation surface of the touch pad 112, considering the operationality.

The setting processing procedure using the setting window 50 shown in FIG. 5 is shown in FIG. 11. In this procedure, when the “setting Pad” item P5 included in those system items that are provided in the top line in any of the tables 60 to 80 shown in FIGS. 6 to 8 is operated, for example, the setting window 50 as shown in FIG. 5 is displayed on the display device 121 (step S41 in FIG. 11).

By user's operations on the setting window 50, desired operation windows (tables) can be set at arbitrary corners of the operation surface of the touch pad 112, taking into consideration the operationality (step S42). For example, the operation range can be arbitrarily set for every corner by operating the range setting section 51 on the setting window 50. In addition, the operation window setting sections 52a to 52d may be operated individually to assign arbitrary tables to the corner regions from pull-down menus. In addition, by operating the button “New” for creation of a new table on the table setting section 53, for example, a new table can be created and registered as a selectable item in the table list (each of the pull-down menus of the operation window setting sections 52a to 52d). An example of setting upon an operation on the button “Detail” for detailed setting will be described later. In addition, the touch wait time to confirm a selecting operation on each corner region set by the range setting section 51 can be set by operating the window open time setting section 54. The transparency of the window can be set by operating the transparency setting section 55. If the “OK” button is operated after any of the setting operations as described above (step S43), the table corresponding to the setting operation is set and held in a predetermined table storage region in the main memory 203 (step S45).

FIGS. 6 to 8 show examples of the configurations of the operation windows set to correspond to the corners of the operation surface of the touch pad 112 via the setting window 50.

In the example of the setting shown in FIG. 5, the operation window listing desktop icons configured as shown in FIG. 6 is set as a desktop table 60 at the left upper corner region of the operation surface of the touch pad 112.

The operation window configured as shown in FIG. 7 is set as a switch window table (window list table) 70 at the right upper corner region of the operation surface of the touch pad 112.

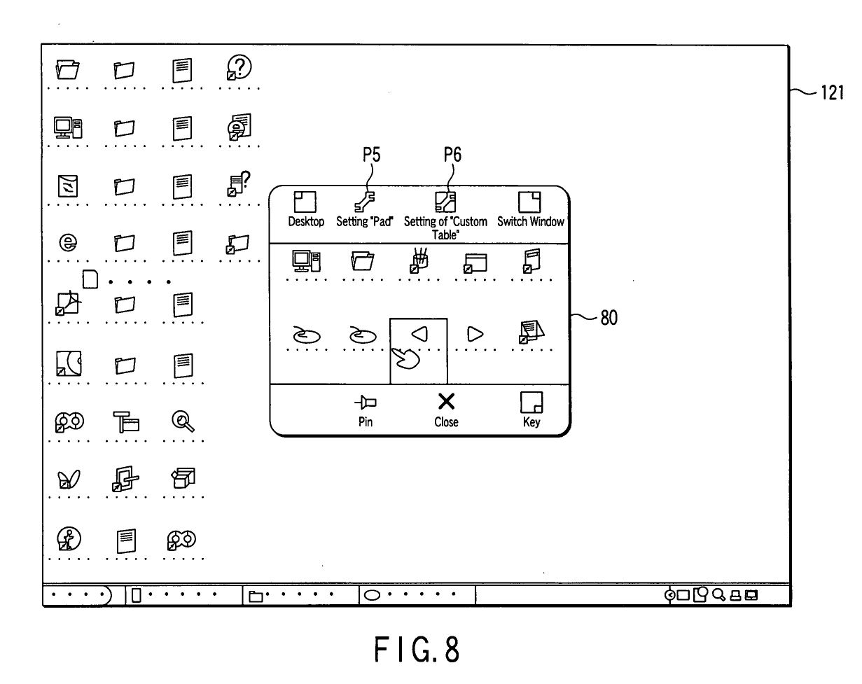

The operation window listing the functions set by the user as shown in FIG. 8 is set as a custom table 80 at the left lower corner region of the touch pad 112. Forty eight items at the maximum can be assigned to the custom table 80 which the user can set up. Those assignable items will be, for example, a file (to execute a corresponding file when selected), a shell object (to execute a shell object such as “My Computer” or the like when selected), a keyboard input (to generate a keyboard input set by the user when selected), a natural keyboard extension key (to execute a browser operation such as “Go,” “Back,” “Refresh,” “Stop,” “Search,” “Favorites,” “Home,” or “Mail,” or a media player operation such as “Mute,” “Volume-Up,” “Volume-Down,” “Previous Track,” “Next Track,” “Stop,” or “Play/Pause”), etc.

In each of the tables 60, 70, and 80, common system items are assigned to the top and bottom lines. These system items will be, for example in this case, an item for switching tables (to switch to another table assigned to another corner region), an application setting item (to display the setting window of the table shown in FIG. 5; “Setting of Pad”), a table setting item (to display the setting window of the custom table (see FIG. 9); “Setting of Custom Table”), a window always-on-display item (to keep the current window open even after the finger is released from the operation surface of the touch pad 112; “Pin”), an item to close the current window (“Close”), etc.

FIG. 9 shows an example of the configuration of the custom table which is displayed when the “Setting of Custom Table” item P6 is selected among the system items provided on the tables 60, 70, and 80, i.e., the table setting item for setting the table as shown in FIG. 8. From the setting window 90 shown in FIG. 9, the custom table 80 shown in FIG. 8 can be set up.

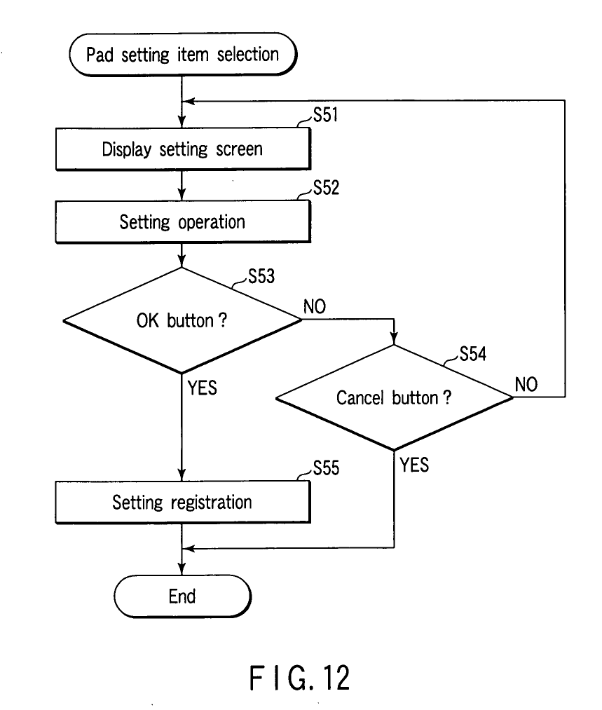

FIG. 12 shows the processing procedure of setting the items of the custom table via the setting window 90. In the processing of assigning items in this procedure, the “Setting of Custom Table” item (P6; see FIG. 8) on any of the tables 60, 70, and 80 is operated to display the setting window 90 as shown in FIG. 9, on the display device 121 (step S51). On the setting window 90 as show in FIG. 9, arbitrary items are drugged and dropped from the tab explorer in the left side into a pad in the right side (step S52). At this time, the positions of the items can be changed by drag and drop. If the “OK” button shown in FIG. 9 is operated after a desired item is dragged and dropped from the tab into the pad in the right side (step S53), the contents of the pad are reflected on the custom table 80 shown in FIG. 8. Thus, the desired item is set on the custom table 80 (step S55). In this setting operation, if any item is dropped to the outside of the pad, the item is deleted from the table.

In the table setting section 53 in the right side of the setting window 50, if the “Detail” button is operated with the “Switch Window” selected from the table list, a detail setting window for the switch window table 70 shown in FIG. 7 is displayed. FIG. 10 shows an example of the configuration of the detail setting window for the switch window table 70. From the setting window 100, it is possible to set whether a preview window should be displayed or not (presence or absence of a preview window), and the transparency of the preview window.

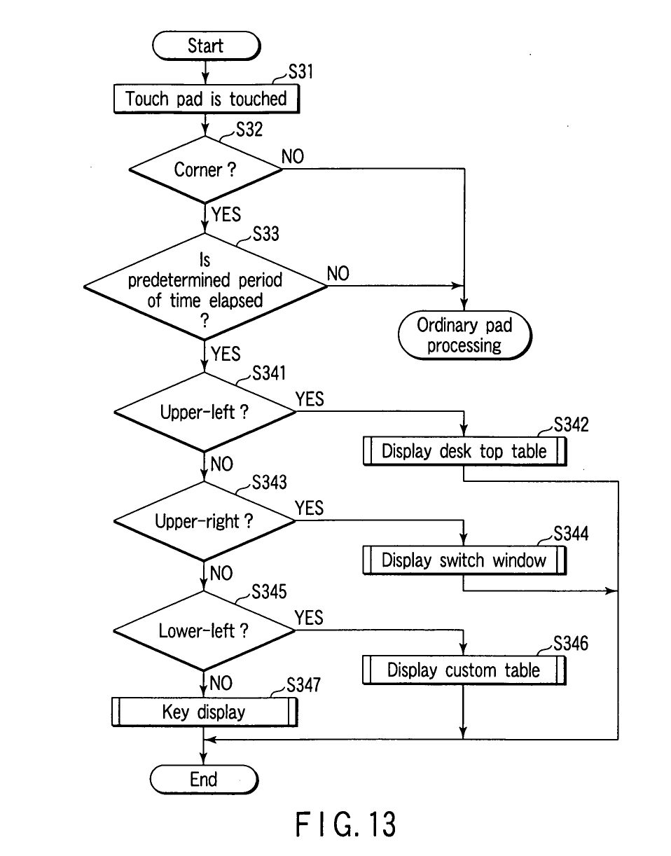

FIG. 13 shows a processing procedure in accordance with a function selection operation via the tables set as described above. This processing is realized by the touch pad utility program (TPU) 215 which is executed by the CPU 201.

In the processing shown in FIG. 13, when a user's finger touches the operation surface of the touch pad 112 (S31), it is determined whether the operating position (coordinates) touched by the finger is within preset corner regions preset by the setting window 50 shown in FIG. 5 or not (step S32).

If the operating position touched is not within the preset corner regions (No in step S32), a normal pad operation processing is performed.

If the touched operating position on the operation window on the touch pad 112 is within the preset corner regions (Yes in step S32), it is further determined whether the operating position touched is kept within the same corner region for a time period (e.g., 0.5 seconds) preset by the setting window 50 or not (step S33). If the operating position touched is not kept within the preset corner region for the preset time period (No in step S33), a normal pad operation processing is performed.

If the operation position touched is kept within the preset corner region for the preset time period (e.g., 0.5 seconds) (Yes in step S33), it is determined which of the four corner regions is the touched corner region. The operation window (table) assigned to the recognized corner region is displayed on the display device 121. Then, any selected function on the table is executed (steps S341 to S347).

In the example of the setting shown in FIG. 5, if the recognized corner region is the left upper corner region of the operation surface of the touch pad 112 (Yes in step S341), the desktop table 60 listing desktop icons as shown in FIG. 6 is displayed (step S342).

If the recognized corner region is the right upper corner region of the operation surface of the touch pad 112 (Yes in step S343), the switch window table 70 as shown in FIG. 7 is displayed (step S344).

If the recognized corner region is the left lower corner region of the operation surface of the touch pad 112 (yes in step S345), the custom table 80 listing the functions set by the user as shown in FIG. 8 is displayed (step S346). If the recognized corner region is the right lower corner region of the operation surface of the touch pad 112 (No in step S345), the setting key table is displayed (step S347).

If the finger touching the operation surface of the touch pad 112 moves and then leaves the surface with a function (item) selected on the operation window (table) while the desktop table 60 or the custom table 80 is displayed, the function (item) selected at this time is executed. The processings for selecting and executing each function are the same as the processing procedure (S11 to S18 in FIG. 4) described previously in the first embodiment.

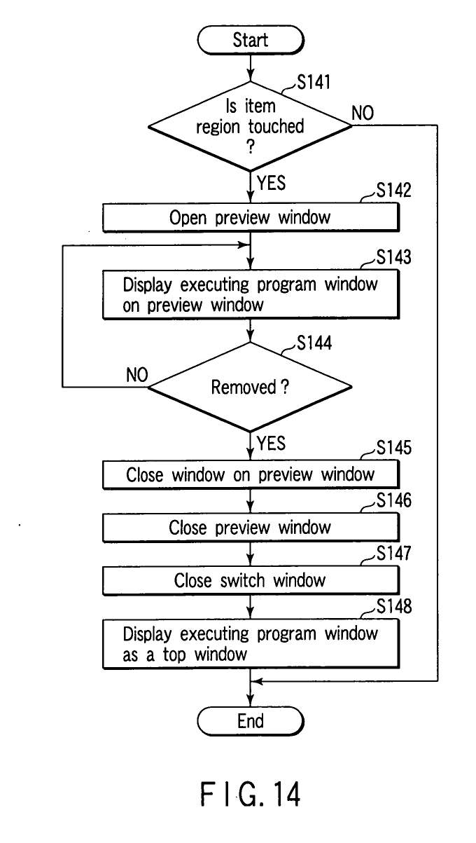

If the position of the finger touching the operation surface of the touch pad 112 moves while the switch window table 70 as shown in FIG. 7 is displayed, the display processing as shown in FIG. 14 is executed. The processing shown in FIG. 14 shows the processing procedure in the case where the setting of displaying a preview window is preset via the detail setting window 100 shown in FIG. 10 for the switch window table 70 (see FIG. 7), i.e., in the case where the check box for “Display Window Preview” is checked on the detail setting window 100 for the switch window table shown in FIG. 10.

In this processing, for example, if the user touches the item of “My Computer” in the switch window table 70 shown in FIG. 7 (Yes in step S141), the “Window Preview” window is opened (step S142), as shown in the figure, and the window of “My Computer” is displayed in the window screen of the “Window Preview” (step S143). At this time, if “Transparency of Preview Window” is set via the setting window 100 shown in FIG. 10, another window (the operation window 70 for “Switch Window” in this case) overlying the window of “Window Preview” is shown with the transparency set via the “Transparency of Preview Window,” as shown in FIG. 7.

If the user's finger leaves the item of “My Computer” (Yes in step S144), the “My Computer” window displayed in the “Window Preview” and the “Window Preview” itself are closed (steps S145 and S146), and further, the operation window 70 for the “Switch window” is closed (step S147). The window screen of the “My Computer” is then placed in the uppermost layer on the desktop screen (step S148).

As has been described above, according to the embodiments of the present invention, an operation window (table) for selecting functions is displayed upon a touch on the operation surface of the touch pad 112, in accordance with the contents set via the setting window. When this operation state transits to another state in which the operation surface is not touched any more, the function selected on the operation window is executed. As a result, the functions each can be selected and executed with the least necessary actions. This improves the operationality in selecting and executing the functions.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. A data processing apparatus comprising:
a display device;
a touch input device;
a detector which detects that the touch input device is touched;
a display controller which displays an operation window listing executable functions on the display device, when it is detected that the touch input device is touched; and
a start-up unit which starts up a function selected from the executable functions listed in the operation window displayed on the display device.

2. The apparatus according to claim 1, wherein the start-up unit comprises a off detector which detects that a finger is released from the touch input device, and the start-up unit starts up a function corresponding to a released position of the finger at the touch input device.

3. The apparatus according to claim 2, wherein the display controller displays a cursor on the operation window, the cursor indicating a touch position on the touch input device.

4. The apparatus according to claim 3, wherein absolute coordinates of the cursor displayed on the operation window have a predetermined relation with respect to absolute coordinates of the touch position on the touch input device.

5. The apparatus according to claim 4, wherein the start-up unit starts up a function corresponding to the cursor displayed on the operation window when the touch operation of the touch input device is stopped.

6. The apparatus according to claim 5, wherein
the detector detects whether one of corner regions of the touch input device is kept touched for a predetermined time period; and
the display controller displays an operation window linked to correspond to the one of the corner region touched on the touch input device when the touch operation is detected by the detector.

7. The apparatus according to claim 6, further comprising a definition unit which defines the operation window and display conditions for the operation window on the display device.

8. The apparatus according to claim 7, wherein the definition unit has a user interface which shows an item visualizing a function as an icon to be selectable via an operation on the touch input device.

9. The apparatus according to claim 6, wherein the operation window includes a window listing desktop icons of the display device.

10. The apparatus according to claim 6, wherein the operation window includes a window list listing windows of programs being currently executed.

11. The apparatus according to claim 6, wherein the operation window includes a window listing functions set by a user.

12. The apparatus according to claim 6, wherein the operation window includes regions listing items usable in common from all operation windows.

13. A function selection method for use in an apparatus comprising an operation device which inputs coordinates of an operating position on an operation surface of the operation device and a display device which displays a display screen where an operation on the operation device is reflected, the method comprising:
displaying an operation window for selecting one of executable functions of the apparatus on the display device when the operation surface of the operation device is touched, and
executing a selected function when a state in which the operation surface of the operation device is touched is stopped.

14. The method according to claim 13, wherein the operation window includes a cursor reflecting an operation on the operation device, and coordinates of the cursor displayed on the operation window have a predetermined relation with respect to coordinates of the operation position of the operation device.

15. The method according to claim 14, wherein the operation window is displayed based on a region of the operation surface of the operation device which is set via a user interface, and a time period for which the set region is touched.

16. The method according to claim 15, wherein the operation window includes at least one of a window listing icons appeared on a desktop, a window list listing windows of programs being currently executed, and a window listing functions set by a user.
